(19) United States
(12) Patent Application Publication
(10) Pub. No.: US 2015/0082891 A1
(43) Pub. Date: Mar. 26, 2015

(54) SYSTEM AND METHOD FOR MEASURING THE VIBRATION OF A STRUCTURE

(71) Applicants: Daniel Boyd Cooper, Christiansburg, VA (US); Erik N. Lee, Houston, TX (US)

(72) Inventors: Daniel Boyd Cooper, Christiansburg, VA (US); Erik N. Lee, Houston, TX (US)

(73) Assignee: BAKER HUGHES INCORPORATED, Houston, TX (US)

(21) Appl. No.: 14/464,135

(22) Filed: Aug. 20, 2014

Related U.S. Application Data
(60) Provisional application No. 61/881,493, filed on Sep. 24, 2013.

(51) Int. Cl. G01H 9/00

(52) U.S. Cl. CPC G01H 9/004
USPC 73/655

(57) ABSTRACT

A system and method for measuring the vibration of a structure of interest are disclosed. The disclosure provides an acoustic isolation structure to substantially reduce response to acoustic energy generated by external physical stimuli. The acoustic isolation structure is formed by placing a housing, such as an outer conduit, around an inner conduit, forming a gap between the housing and the inner conduit. The gap is then configured to serve as an acoustic isolation layer by either filling the gap with an acoustic isolation material or by substantially evacuating the gap and sealing the ends thereof.

### CROSS REFERENCE TO RELATED APPLICATIONS

This application claims the benefit of an earlier filing date from U.S. Provisional Application Ser. No. 61/881,493 filed Sep. 24, 2013, the entire disclosure of which is incorporated herein by reference.

### BACKGROUND

The present disclosure relates generally to system and method for measuring the vibration of a structure of interest. More particularly, the disclosure relates to a system and method for measuring the vibration of a production tubing component or the like.

Cables, particularly fiber optic cables, are used ubiquitously in the downhole drilling and completions industry. These cables are used for monitoring a variety of downhole conditions and parameters, such as temperature, vibration, sound, pressure, strain, etc. Due chiefly to their pervasive use, there is an ever-present desire in the industry for alternate styles of sensing cables, particularly for enhancing the ability to more accurately sense a specific parameter.

### SUMMARY

Disclosed herein is a distributed disturbance sensing system that includes an acoustic isolation structure. A sensing cable is contained within a control line. The control line, in turn, is surrounded by a housing. The housing is arranged around the control line to maintain a gap between the housing and the control line. The gap is filled with an acoustic isolation material.

Also disclosed herein is a system for measuring the vibration of a production tubing. A sensing cable is contained within an inner conduit, with an outer conduit surrounding the inner conduit. The outer conduit is coupled to the production tubing. A number of rings are placed connecting the outer conduit and inner conduit. The placement of the rings forms at least one elongated chamber between the respective conduits that is configured to decrease response to acoustic energy.

Also disclosed is a method for isolating a distributed acoustic sensing system from external acoustic sources. A sensing cable is arranged within an inner conduit. The inner conduit is concentrically arranged within an outer conduit, forming a gap in the space between the conduits. The gap is configured to serve as acoustic isolation layer and the outer conduit is coupled to a structure of interest.

### BRIEF DESCRIPTION OF THE DRAWINGS

The following descriptions should not be considered limiting in any way. With reference to the accompanying drawings, like elements are numbered alike:

FIG. 1 depicts a sectioned side view of a distributed acoustic sensing system within an acoustic isolation structure, as employed in one embodiment;

FIG. 2 depicts sectioned side view of a distributed acoustic sensing system within an acoustic isolation structure, in accordance with another embodiment; and

FIG. 3 depicts a system for sensing the vibration of a production tubing, in accordance with another embodiment

FIG. 4 depicts an alternate embodiment with a part annular outer conduit.

### DETAILED DESCRIPTION

A detailed description of one or more embodiments of the disclosed apparatus and method are presented herein by way of exemplification and not limitation with reference to the Figures. It is to be understood that other embodiments may be utilized and changes may be made without departing from the scope of the present disclosure. In particular, the disclosure provides various examples related to measuring the vibration of a production tubing, whereas the advantages of the present disclosure as applied in a related field would be apparent to one having ordinary skill in the art and are considered to be within the scope of the present invention.

Distributed Acoustic Sensing (DAS) systems use fiber optic cables as sensing cables to detect pressure waves and dynamic strain in a structure. This technology measures the dynamic strain applied to the fiber, and is often sensitive to dynamic strain from a variety of sources. While a signal proportional to the accumulative dynamic strain resulting from all sorts of physical stimuli may be desirable in some applications, it may also be desirable to limit the sensing ability of a DAS system to respond primarily to a single source or limited group of physical stimuli. For example, a downhole deployment of a DAS system utilizing a sensing cable contained within a control line coupled to a production tubing is sensitive not only the vibration of the production tubing, but is also sensitive to a variety of acoustic signals that propagate through the surrounding structure. The present disclosure provides a distributed disturbance sensing system, targeting the response to the vibration of the structure, while substantially eliminating the response to acoustic energy.

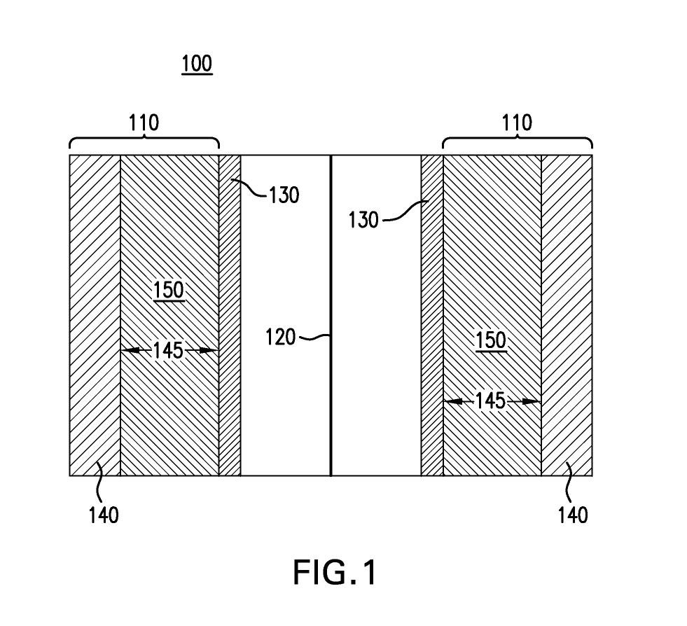

The present disclosure provides a system and method for reducing the effect of external vibrations, in particular, acoustic vibrations, thereby increasing the effective sensitivity of the system to the local structural dynamic response of a structure of interest. Referring to FIG. 1, one embodiment comprises a distributed acoustic sensing system 100 having an acoustic isolation structure 110 surrounding a sensing fiber 120 contained in an inner conduit 130, which may be referred to as a control line. The acoustic isolation structure 110 is formed by surrounding the inner conduit 130 with a housing 140. The housing 140 is arranged to form a gap 145 surrounding the control line. The gap 145 is configured to serve as an acoustic isolation layer, for example, by placing an acoustic isolation material 150 within the gap 145 or configuring the gap to hold a vacuum.

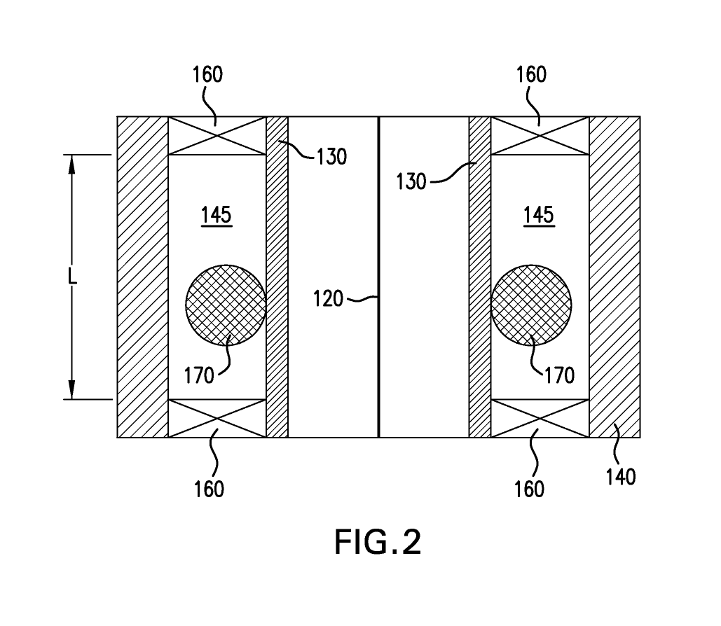

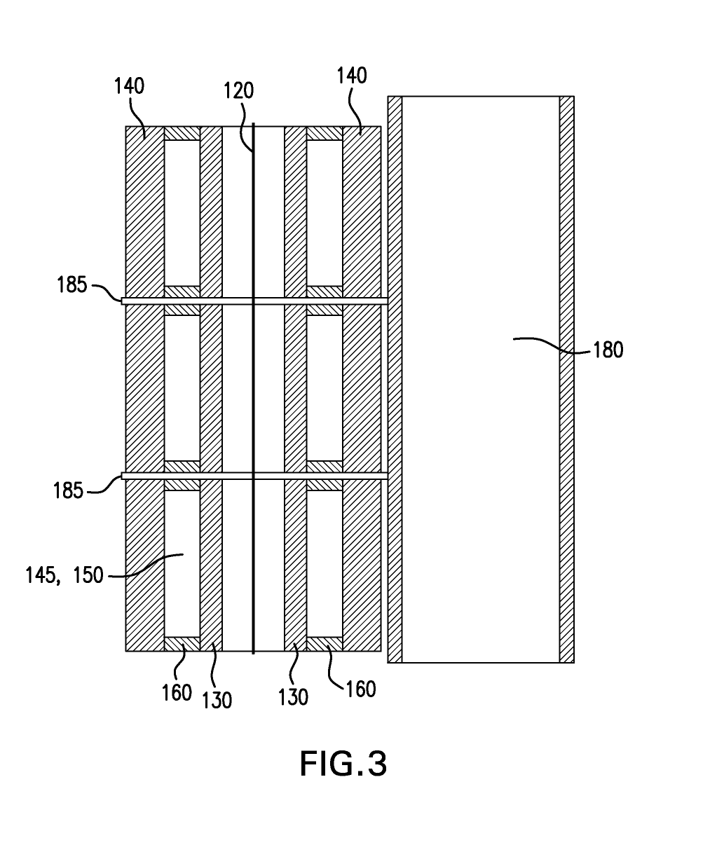

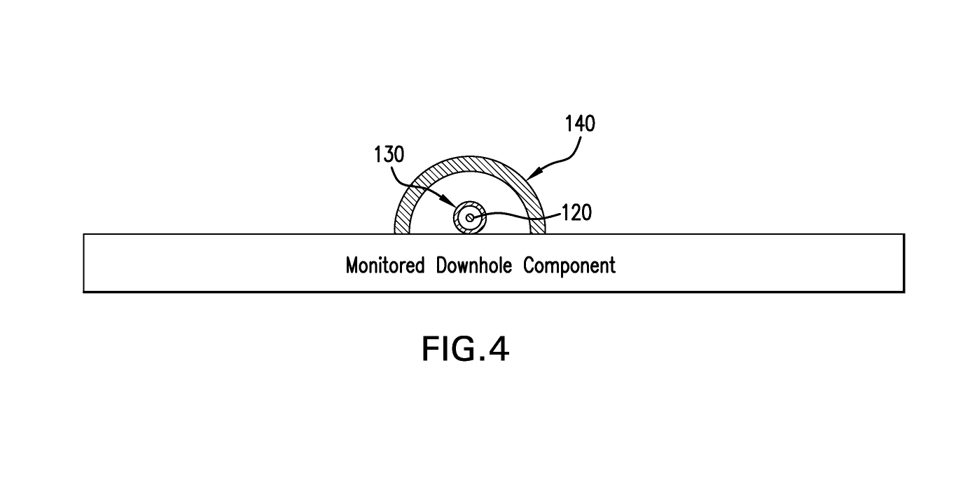

Referring to FIG. 2, another embodiment comprises an acoustic isolation structure in which the housing 140 surrounding the inner conduit 130 is an outer conduit. In some examples the outer conduit is substantially concentrically arranged with respect to the inner conduit 130, providing the sensing cable with isolation from external sources of acoustic energy in all radial directions. Alternatively, the inner and outer conduit may be eccentrically arranged, for example, with an axis of the inner conduit arranged closer to the structure of interest, such as a production tubing 180 (see FIG. 3) or the outer conduit 140 may be configured as part annular, for example the outer conduit may be configured as a 180 degree portion of the conduit illustrated in the foregoing figures. The conduit then would be mounted to a configuration of interest (Monitored Downhole Component) as illustrated in FIG. 4 with the inner conduit 130 in contact with the monitored downhole component, the fiber 120 being within the inner conduit 130. It is to be understood that although a 180 degree part annular form of conduit 140 is illustrated, it is contemplated that the number of degrees represented by the part annular conduit may be from greater than zero to less than 360 in alternate embodiments. Further, although the term “annular” has been used and illustrated, its definition is intended to be loosely adhered to such that cross sectional shapes other than circular are also included.

A number of caps 160 may be arranged to form barriers or seals at the ends of the outer conduit or somewhere between. The caps 160 may be fittings that are attached to the respective conduits. Alternatively, the caps 160 may be seals that are fused or welded or otherwise configured to hold a pressure differential in the respective conduits. In any case, caps 160 enclose the gap 145 to form an elongated chamber. Also depicted in the illustrated embodiment is a spacer 170. One or more spacers, such as o-rings, may be included in the system of the present disclosure, which may be used to maintain the size of the gap 145 and to prevent contact between the housing 140 and the inner conduit 130.

The inner conduit 130 may be provided in the form of a conduit or other control line, as presently used within the art. The inner conduit 130 may be formed of a metal or composite material. In some embodiments, the inner conduit 130 and other components are constructed to resist high temperatures and pressures, such as experienced, for example, in a downhole production tubing. The housing 140 may be an outer conduit, as described above, or may comprise another elongated structure that forms an elongated enclosure or gap between the housing and inner conduit 130.

The gap 145 formed between the housing 140 and the inner conduit 130 may take the form of an elongated enclosure, particularly where the caps 160 are used to enclose the ends thereof. The distance between the caps 160 is denoted as the gap length L. In some embodiments, such as where the housing comprises an outer conduit, the gap is formed by arranging the outer conduit and inner conduit in a substantially concentric configuration. This concentric arrangement may be maintained using a plurality of spacers 170, or by placing caps 160 at various distances along the gap.

The gap 145 forms an acoustic isolation layer. In some embodiments, such as shown in FIG. 2, the acoustic isolation layer may be configured by substantially evacuating the chamber or gap. In this example, it is necessary to employ sealing techniques to form the caps 160 as seals. The seals may be formed using an opposing ferrule seal method (a dual metal seal) or other sealing method that meets the environmental requirements of a particular application. Other applications that may require some sort of seal include the use of the present system in connection with a production tubing, where, for example, wellbore fluids may interfere with the acoustic isolation layer.

The acoustic isolation material 150 may be chosen for a particular application. For example, some applications may have very extreme temperature and pressure requirements. Where temperature and pressure are important considerations, the acoustic isolation material may be, by way of example: a metallic mesh; an inorganic fibrous material; a silica or silica gel; an expanded resin material; an engineered foam; or a composite material that may employ one or more of the other materials listed as one component of the composite.

Referring to FIG. 3, one embodiment of the present disclosure includes a acoustic isolation structure 110 that includes a plurality of caps 160 or seals at equal distances along a length of a production tubing 180. The acoustic isolation structure is arranged, for example, by coupling the housing 140 or outer conduit to the production tubing with a coupling 185. In the illustrated example, the distance between the various caps 160 or seals is chosen to correspond to the distance between the couplings 185.

The distributed acoustic sensing system 100 may further encounter vibrations along the length of the fiber optic cable. The frequency of such vibrations may be calculated and controlled by selecting a gap length L that corresponds to a particular frequency. Such calculations may be estimated by using known values, such as the stiffness of the materials chosen for the inner and outer conduits, or by using empirical data.

In some examples of the present disclosure, the gap length L is chosen to correspond to a frequency range that is substantially free from overlap with the expected frequency range of the vibrations of the structure of interest. The caps 160 may be arranged at equal distances to correspond to a desired gap length L. In other examples, such as where an estimate of the expected frequency range of the vibration of the structure of interest is unavailable, the frequency of vibration that corresponds to the gap length L is known and can be substantially filtered when processing the sensing signal.

For example, in downhole operations the pipe flow will often generate broadband vibration. In such applications, it is expected that the measurements will require a frequency range extending up to 2000 to 2500 Hz. This knowledge may be used to select an appropriate gap length, likely resulting in short sections of the distributed disturbance sensing system to be chosen to include acoustic isolation structures at depths of interest. Other portions of the distributed disturbance sensing system would operate as a typical system. Another application of such an arrangement would be to use portions of the distributed disturbance sensing system to serve as an aggregate sensor, which responds to all types of physical stimuli. The measured vibration of the acoustic isolation portion of the system can be subtracted from the signal of the aggregate sensor to determine the observable acoustic energy of the environment, independent of the measured vibration of the structure of interest.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc., do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A distributed disturbance sensing system having an acoustic isolation structure, comprising:
a sensing cable contained within an inner conduit, the inner conduit being contained within a housing, the housing and the inner conduit respectively arranged to maintain a gap between an inner surface of the housing and the outer surface of the inner conduit for a substantial length of the housing, the housing being coupled to a structure of interest; and
an acoustic isolation material contained within the gap.

2. The system of claim 1, the structure of interest comprising a production tubing or a casing.

3. The system of claim 1, the acoustic isolation material comprising one or more of a metallic mesh, an inorganic fibrous material, a silica or silica gel material, an expanded resin material, or an engineered foams or composite material.

4. The system of claim 1, the inner conduit comprising a conduit formed of a metal or a composite material.

5. The system of claim 1, the housing comprising an outer conduit surrounding the control line.

6. The system of claim 5, the outer conduit being part annular.

7. The system of claim 1, the housing comprising an elongated enclosure that encompasses a portion of the inner conduit.

8. The system of claim 1, further comprising at least one seal joining an end of the housing to the control line.

9. The system of claim 1, the gap being maintained by one or more o-rings.

10. A system to measure the vibration of a downhole component of interest, comprising:
an inner conduit housing a sensing cable;
an outer conduit surrounding a length of the inner conduit, the outer conduit being coupled to a downhole component of interest;
a plurality of caps connecting the outer conduit to the inner conduit;
at least one elongated chamber enclosed between the outer surface of the inner conduit and the inner surface of the outer conduit, the ends of the chamber being bounded by two of the plurality of caps; the elongated chamber being configured to dampen acoustic vibrations.

11. The system of claim 10, at least two of the plurality of caps comprising a seal.

12. The system of claim 10, the at least one elongated chamber being substantially evacuated.

13. The system of claim 10, the plurality of rings being substantially equally spaced along a length of the outer conduit.

14. The system of claim 13, the spacing between each of the plurality of rings being chosen to reduce acoustic noise in a frequency range of interest.

15. The system of claim 10, the at least one elongated chamber containing an acoustic isolation material.

16. The system of claim 15, the acoustic isolation material comprising one or more of a metallic mesh, an inorganic fibrous material, a silica or silica gel material, an expanded resin material, or an engineered foams or composite material.

17. A method for isolating a distributed acoustic sensing system from external vibration sources, comprising:
arranging a sensing cable within an inner conduit,
arranging the inner conduit within an outer conduit, the inner conduit and outer conduit being arranged to form a gap between an outer surface of the inner conduit and an inner surface of the outer conduit; and
configuring the gap to serve as an acoustic isolation layer.

18. The method of claim 17, comprising sealing the outer conduit to the inner conduit in at least two locations.

19. The method of claim 18, comprising configuring the gap to serve as an acoustic isolation layer by substantially evacuating the gap.

20. The method of claim 19, comprising selecting a distance between the at least two locations by choosing an expected frequency of vibration the inner conduit and the outer conduit.

21. The method of claim 17, comprising configuring the gap to serve as an acoustic isolation layer by placing an acoustic isolation material in the gap.
